(19) United States
(12) Patent Application Publication
(10) Pub. No.: US 2025/0345955 A1
(43) Pub. Date: Nov. 13, 2025

(54) BOX CUTTER PRODUCTS AND RELATED METHODS

(71) Applicant: MAZE INVESTMENT GROUP B.V., Geleen (NL)

(72) Inventor: Stefan M. C. G. A. R. ZENTVELD, Geleen (NL)

(21) Appl. No.: 18/860,932

(22) PCT Filed: Apr. 26, 2023
(86) PCT No.: PCT/EP2023/061027

§ 371 Date: Oct. 28, 2024

(30) Foreign Application Priority Data
Apr. 28, 2022 (NL) 2031724

(51) Int. Cl. B26B 3/08; B65D 5/44

(52) U.S. Cl. CPC B26B 3/08; B65D 5/44

(57) ABSTRACT

A method for attaching a box cutter to a box. The method includes the steps of arranging the box cutter on an outer surface of the box; and attaching the box cutter to the outer surface. In a second aspect of the invention, there is provided a method for opening a box closed with adhesive tape, wherein a box cutter is attached to the box according to the method mentioned above. The method includes the steps of at least partially removing the sheet from the box cutter to gain access to the box cutter; removing the box cutter from the outer surface of the box; and cutting the adhesive tape with the box cutter.

### FIELD OF THE INVENTION

The invention relates to a method for attaching a box cutter to a box. Further, the invention relates to a method for opening a box closed with adhesive tape using the box cutter attached to the box. Further, the invention relates to the box cutter for use in the methods. Further, the invention relates to a box opening assembly for use in the methods comprising the box cutter. Further, the invention relates to a box having the box opening assembly.

### BACKGROUND OF THE INVENTION

Cardboard boxes are widely used to package products. The cardboard box provides several functions. The cardboard box provides protection of the product inside the box, for example, it protects the product from being scratched or dented. The cardboard box allows for easy stacking of products, which allows more products to be stored in warehouses or delivery vehicles. Further, the cardboard box may be provided with labels with information, such as details of the contents of the box, the address to which the box is to be delivered, etc.

There is a trend that more and more products are ordered online and delivered via a delivery system to the customer that ordered to product. To ensure that the product reaches the customer without any damage, the sender of the product puts the product in a box. Optionally, the sender includes additional protective materials inside the box, such as bubble wrap or bubble plastic, crinkle paper or air pillows. The additional protective material helps to protect the product in case the box is dropped or dented.

Despite the good care the sender typically takes when packaging the product in the box, yearly millions of products are returned by customers, because of damage to the product. In many cases, the damage to the product occurs when the customer opens the cardboard box. The following problem occurs when the cardboard box is closed with adhesive tape. To open the box, the customer in many cases takes a sharp object, such as a knife or a key or whatever sharp object is within reach of the customer. Careless cutting the adhesive tape often results in accidently cutting the product just beneath the adhesive tape. Many customers return the product to the sender even though the customers themselves have damaged the product by carelessly cutting the adhesive tape. The sender has to return the money for the product, but is not able to sell the damaged product to another customer, resulting in a loss to the sender.

Other customers tear the adhesive tape from the box by hand, tearing the cardboard as well. As this damages the box, the box cannot be reused. Also, the customer may wish to return the still undamaged product to the sender, for example because the customer dislikes the color of the product. However, due to the damaged cardboard box, the product may be damaged on the return trip to the sender. The sender has to return the money for the product, but is not able to sell the damaged product to another customer, resulting in a loss to the sender.

Some senders try to reduce the risk of a customer damaging the product while opening the box. A known option is to provide a cardboard box that is sufficiently large to create a distance between the product and the outer surfaces of the box. The cardboard box needs to be filled with a filling material to ensure the product is constrained at the distance from the outer surfaces. Because the customer may open the box at various locations, for example at the top side or the bottom side of the box, the box needs to be substantially larger than the product. As a result, shipping such a large box is more expensive.

To allow the customer to open a box without damage to the product, a zipper box may be used. A zipper box is a cardboard box that has a perforated portion. The perforated portion allows a strip of cardboard to be pulled from the box. The pulling of the strip from the box resembles opening a zipper, hence the name zipper box. By removing the strip, the box is opened. Although damage to the product may be prevented, the zipper box is much more expensive than a traditional cardboard box without zipper. Also, once the zipper box has been opened, the zipper box cannot be reused again. The only option is to recycle the zipper box. Because the energy to recycle cardboard becomes more and more expensive, and because cardboard becomes scarcer due to the excessive use of cardboard, it is preferred to reuse cardboard boxes.

### SUMMARY OF THE INVENTION

It is an objective of the invention to improve the way the customer opens the box, or at least to provide an alternative way. Optionally, the invention allows reuse of the cardboard box. Optionally, the invention reduces the risk of damage to a product while opening the box.

The objective of the invention is achieved by a method for attaching a box cutter to a box. The method comprises the steps of arranging the box cutter on an outer surface of the box; and attaching the box cutter to the outer surface.

By arranging the box cutter on the outer surface of the box, the customer is able to take the box cutter before opening the box. Because the box cutter is available on the box, the customer has the right tool available at the box to open the box. There is no need for the customer to tear open the box by hand or to use any other object, such as a key, to cut the adhesive tape with a high risk of damaging the product inside the box. This way the customer is able to use the box cutter to properly cut adhesive tape to open the box without damage. This allows the box to be reused by simply adding some further adhesive tape.

The box cutter is a device suitable for opening the box. The box cutter has a cutting edge that is able to cut through the adhesive tape. The box cutter is, for example, able to cut through cardboard. However, in an example, the box cutter is not able to cut through the cardboard of the box, but is able to cut through adhesive tape. The box cutter is, for example, small enough to extend partly into the space between two major flaps of a closed box to cut the adhesive tape adhered to both major flaps. The box cutter is, for example, small enough to extend partly into the space between a major flap and a minor flap of a closed box to cut the adhesive tape that extends over that space. For example, the box has a base and a lid for closing the base. In this example, the box cutter is able to extend partly into the space between the lid and the base to cut the adhesive tape that secures the lid to the base. Note that in the examples above, the box cutter is able to extend in the spaces mentioned without damaging the box.

The box is a box suitable for safe transport of a product inside the box. The box is, for example, a delivery box. When referring to a box in the context of the invention, a cardboard box is intended because the cardboard box is the standard box for delivering products. However, the invention is not limited exclusively to cardboard boxes. For example, the box comprises another type of heavy paper-based product than cardboard, such as paperboard or fiberboard. For example, the box is a plastic box.

The box may have any suitable shape, such as square or rectangular or cylindrical. The box may be any suitable type of box. For example, the box is a regular slotted container. For example, the box is a half slotted container. For example, the box has a lid and a base. For example, the lid and the base are only connected to each other via adhesive tape. For example, the lid and the base are hinged to each other.

The outer surface of the box is a surface that is visible and reachable when the box is closed. The customer is able to take the box cutter from the outer surface of the box without first opening the box. For example, the adhesive tape that is to be cut by the box cutter is adhered to the outer surface on which the box cutter is arranged. This way, the customer is guided to the specific adhesive tape that is to be cut. By guiding the customer towards the specific adhesive tape, the sender may place filler material directly beneath the specific adhesive tape. The filler material is between the specific adhesive tape and the product. When cutting the specific adhesive tape with the box cutter, only the filler material may be damaged, but not the product. By guiding the customer in this way, less filler material is needed. For example, filler material is provided only on the top side of the product, but not at the bottom side of the product.

In an embodiment, the step of attaching the box cutter to the outer surface comprises the step of gluing the box cutter to the outer surface.

According to this embodiment, the box cutter is attached to the box in a simple and cost-effective way. The glue is strong enough to hold the box cutter during transport of the box, whereas the glue is weak enough to allow the customer to remove the box cutter from the box without damaging the box. The glue is, for example, provided by one or more glue dots arranged between the box cutter and the outer surface of the box. The glue is, for example, provided by double sided tape arranged between the box cutter and the outer surface of the box. One side of the double sided tape adheres to the box, whereas the other side of the double sided tape adheres to the box cutter.

In an embodiment, the method comprises the step of providing a depression in the outer surface of the box. The step of arranging the box cutter on the outer surface of the box comprises arranging the box cutter in the depression.

According to this embodiment, the depression provides a space in which the box cutter is at least partly arranged. This way, the box cutter extends only a little or not at all from the outer surface of the box. This allows for an improved stacking of boxing. Also, the risk to the box cutter from being detached accidentally from the box is reduced. The depression is, for example, provided by embossing part of the outer surface of the box. The depression is, for example, providing by a cutout in the outer surface of the box.

In an embodiment, the step of attaching the box cutter to the outer surface comprises the steps of arranging a sheet at least partly over the box cutter; and attaching the sheet to the box.

By arranging the sheet at least partly over the box cutter and attaching the sheet to the box, the box cutter is fixed to the box. This way, the box cutter is securely fixed to the box. For example, the sheet completely covers the box cutter. In another example, the sheet covers the box cutter only partial. The sheet is with or without an opening. In the example that the sheet has an opening, the opening is too small for the box cutter to move through the opening. For example, the sheet has a mesh structure. By providing the sheet with one or more opening, the sheet is formed with less material while still properly attaching the box cutter to the box. The sheet is for example a paper sheet or a plastic sheet or a cardboard sheet. The sheet is attached to the box for example with a glue or any other adhesive. For example, the sheet is stapled to the box. For example, the sheet has one or more protrusions that are formed to cooperate with one or more openings in the box or vice versa. The sheet is attached to the box by interlocking the protrusion or protrusions with a corresponding opening. For example, the sheet is part of an envelope. The box cutter is provided inside the envelope. Then the envelope is attached to the box. In this example, the box cutter is not directly arranged on the outer surface of the box, but a part of the envelop is in between the box cutter and the outer surface. For example, in this embodiment, the box cutter itself may not need to be contact with any adhesive. Instead, the box cutter may be fully covered by the sheet, wherein only the parts of the sheet surrounding the box cutter may be provided with adhesives.

In an embodiment, the sheet is an address label.

According to this embodiment, the address label is used to attach the box cutter to the box. The address label contains information about the address to which the box is to be delivered. The address label contains, for example, other information such as the address of the sender. The box cutter is for example, arranged on the outer surface of the box beneath a part of the address label containing address information. This is acceptable, for example, if the box cutter has a substantial uniform thickness and/or a small thickness, for example, of less than 1 mm. This way, the information on the address label is readable while the box cutter is beneath the address label. In another example, the box cutter is arranged on the outer surface beneath a part of the address label that does not contain address information. For example, the address label is extended to provide the part without the information to cover the box cutter.

In an embodiment, the sheet is a sticker.

According to this embodiment, a sticker provides a simple and cost-effective way to attach the box cutter to the box. For example, the sticker contains information on how to use the box cutter. The sticker is, for example, placed near the adhesive tape that is to be cut.

In an embodiment, the sheet has a transparent portion. The step of arranging the sheet over the box cutter comprises the step of arranging the transparent portion over at least part of the box cutter to allow the box cutter to be visible through the sheet.

According to this embodiment, the box cutter is visible via the transparent portion while the box cutter is attached to the box with the sheet. This allows the customer to easily identify and find the box cutter. For example, the transparent portion comprises a transparent plastic or glassine. Glassine is a smooth and glossy paper that is translucent.

In a second aspect of the invention, there is provided a method for opening a box closed with adhesive tape, wherein a box cutter is attached to the box according to the method mentioned above. The method comprises the steps of at least partially removing the sheet from the box cutter to gain access to the box cutter; removing the box cutter from the outer surface of the box; and cutting the adhesive tape with the box cutter.

According to the second aspect, a customer is provided with the box cutter attached to the outer surface of the box as mentioned above. To open the box, the customer removes at least part of the sheet to uncover the box cutter. The box cutter is then taken from the outer surface of the box and used to cut the adhesive tape to open the box.

The sheet is, for example, removed only partially from the box to expose part of the box cutter. The exposure part of the box cutter is then pulled to slide the box cutter out from below the remainder of the sheet. The sheet is, for example, removed completely from the box to fully expose the box cutter.

The adhesive tape may be any suitable tape with which to close the box. The adhesive tape is, for example, packaging tape or paper tape or scotch tape.

In an embodiment, the sheet has a pull tab for removing the sheet from the box. The step of at least partly removing the sheet from the box cutter comprises pulling the pull tab.

According to this embodiment, the pull tap allows the sheet to be pulled easily from the box to expose the box cutter.

In an embodiment, the box cutter is attached to the box in a substantially two-dimensional state, and the method further comprises, after the step of removing the box cutter, the step of bending the box cutter into a substantially three-dimensional state.

This embodiment may offer the benefit that the box cutter can be relatively flat during shipping of the box. In the two-dimensional state, the box cutter does not take up a large amount of space, which is beneficial for the shipping efficiency. Meanwhile, the box cutter can be bent into the three-dimensional shape to be conveniently gripped by users, in order to make cutting of the tape more user friendly.

In a third aspect of the invention, there is provided a box cutter for use in one or both of the methods of the first aspect and the second aspect, which box cutter is for opening the box closed with adhesive tape extending in a tape plane. The box cutter comprises a body having a first portion and a second portion, wherein the first portion and the second portion are bendable relative to each other between:
a substantially two-dimensional state, in which the first portion and the second portion) extend co-planar with each other, and
a substantially three-dimensional state, in which the first portion and the second portion extend at a bending angle relative to each other,
wherein the first portion is provided with a cutting edge to cut the adhesive tape when moving the box cutter relative to the adhesive tape in a cutting direction in the tape plane, wherein the cutting edge projects in a cavity of the second portion in the two-dimensional state of the box cutter, and wherein the cutting edge projects away from the second portion in the three-dimensional state of the box cutter at a cutting depth in a direction perpendicular to the tape plane.

According to the third aspect, to cut the adhesive tape with the box cutter, the box cutter is placed so that the adhesive tape is contacted by the cutting edge. This may either be at the side of the box, at the edge of the adhesive tape, or the box cutter may be punctured into the adhesive tape.

The box cutter comprises a first portion and a second portion, which portions are intended to be bent relative to each other during use of the box cutter. The first portion and the second portion are connected to each other through integral bending hinges The box cutter is configured to be arranged in the substantially two-dimensional state during shipping of the box to which the box cutter is attached. In this two-dimensional state, the box cutter extends substantially in a single plane, in which it is relatively flat to take up as little space as possible, to be substantially flush with the outer wall of the box.

After the shipping, when the user intends to open the box and to cut the adhesive tape, the box cutter is intended to be bent into its three-dimensional shape. This bending involves bending of the first portion of the box cutter relative to the second portion, after which both portion extend at the bending angle relative to each other.

The box cutter comprises the cutting edge that is provided on the first portion. In the two-dimensional state of the box cutter, the cutting edge is accommodated in a cavity of the second portion, in order to be substantially shielded, i.e. to avoid damaging of any sheet or other type of covering over the box cutter during shipping of the box.

Upon bending of the first and second portions of the box cutter, the cutting edge is moved out of the cavity, in order to be exposed and to be able of cutting the adhesive tape. The cutting edge thereby projects away from the second portion to project beyond, i.e. underneath, the second portion.

During cutting, the box cutter is intended to be placed on the adhesive tape with the second portion. As such, the cutting edge projects into the adhesive tape, whereas the second portion resting on the adhesive tape prevents the cutting edge from sinking too deep into the box. In this position, at least part of the cutting edge extends inside the box. Because the product is inside the box, the cutting edge could have the potential to damage the product, but the present invention provides that a cutting depth of the cutting edge is relatively low, compared to the thickness of the box wall. For example in case the box walls were to be made of corrugated cardboard, the cutting edge would only cut through an outer surface layer of the corrugated cardboard, not cutting through the opposed inner surface layer. As a result, the box cutter reduces the risk of the product being damaged while opening the box.

The cutting edge may be arranged to cut the adhesive tape starting at the edge when moving the box cutter in the cutting direction. When the edge of the adhesive tape is in contact with the cutting edge, in which the cutting edge is able to cut the edge of the adhesive tape, a first portion of the cutting edge may extend on one side of the tape, whereas the a second portion of the cutting edge may extend on the opposite side of the tape. The first portion extends on one side of the tape plane, whereas the second portion extends on the opposite side of the tape plane. For example, in this position, the first portion extends outside the box, whereas the second portion extends inside the box, i.e., within a space defined by the outer surfaces of the box.

The tape plane is a plane defined by the length and the width of the adhesive tape. The adhesive tape has an adhesive on one side of the tape plane and no adhesive on the other side of the tape plane. When cutting the adhesive tape, the cut is made in the tape plane in the length direction, the width direction or a combination of the length direction and the width direction.

In an embodiment, the bending angle is defined in the range between 45° and 135°, preferably between 60° and 120°, for example about 90°.

According to this embodiment, the bending angle is limited within this range. It was found by the present inventor that a bending angle in this range, especially a bending angle of 90°, may be beneficial for the users of the box cutter, to be gripped conveniently during cutting of the adhesive tape.

In an embodiment, the cutting depth is defined in the range between 1 mm and 5 mm, preferably between 2 mm and 4 mm, for example about 3 mm.

According to this embodiment, the portion of the cutting edge extending into the box has a height defined in this range. It was found by the present inventor that a cutting depth in this range may be sufficiently deep to effect reliable cutting of the adhesive tape, whilst not being too deep, in order to prevent damaging of the products inside the box.

In an embodiment, the box cutter further comprises a third portion, which is functionally arranged between the first portion and the second portion, configured to guide the bending between the first portion and the second portion.

According to this embodiment, the third portion is bendably connected to the first portion and the second portion, being connected to the first portion and the second portion through integral bending hinges. During bending of the first portion relative to the second portion, the mutual position with the third portion is changed accordingly. As such, the third portion may have influence on the bending of the first portion and the second portion, in order to ensure that the box cutter is correctly bent into the three-dimensional state. As such, the box cutter may be operated more reliably by new and unskilled users.

In a further embodiment, the third portion is further configured to prevent bending between the first portion and the second portion beyond the bending angle.

According to this embodiment, the third portion may be configured to allow bending of the first portion relative to the second portion as long as the angle between the first and second portion, i.e. starting a 0° in the two-dimensional state, has not yet reached the bending angle. However, when the angle between the first and second portion does reach the bending angle, the third portion is configured to stop further bending, so that the box cutter accurately ends up in the three-dimensional state. Over-bending beyond the bending angle is thereby prevented, which may further improve usage of the box cutter by new and unskilled users.

In an embodiment, the box cutter further comprises a connecting element between the third portion and the second portion.

According to this embodiment, the third portion may be directly connected to the first portion and indirectly connected to the second portion. The length of the connecting element may determine the bending angle between the first portion and the second portion in conjunction with the third portion. If, for example, the length of the connecting element is relatively short, the bending angle may be relatively small, whereas the bending angle may be relative larger when the length of the connecting element is relatively long.

In an embodiment, the third portion extends co-planar with the first portion and the second portion in the two-dimensional state of the box cutter and the third portion extends at a tail angle relative to the second portion and the cutting direction in the three-dimensional state of the box cutter.

According to this embodiment, the third portion may lie in the same plane as the first and second portions in the two-dimensional state of the box cutter. The third portion is then bent out of the plane of the second portion when the box cutter is brought into the three-dimensional state. In the three-dimensional state, the third portion may beneficially act as a skid plate to facilitate sliding of the second portion of the box cutter over minor obstructions on the adhesive tape and the box wall.

The tail angle of the third portion may, but not necessarily needs to be the same as the bending angle between the first portion and the second portion. There may be a dependence between the tail angle and the bending angle, which dependence may, for example, be determined by the length of the connecting element between the third portion and the second portion.

In an embodiment, in the three-dimensional state of the box cutter, the second portion forms a guiding plane facing the tape plane and extending parallel to the tape plane, wherein the guiding plane is adapted to support and guide the box cutter along the box in the cutting direction, and wherein the guiding plane is adapted to move along the adhesive tape in the cutting direction.

According to this embodiment, the guiding plane helps to guide the box cutter along the box in the cutting direction. Because the guiding plane faces the tape plane and extends parallel to the tape plane, the guiding plane helps to guide the box cutter along the box while reducing the risk of placing the box cutter, e.g. the cutting edge thereof, too deeply into the box. The adhesive tape forms a support for the guiding plane as a result. This way, the risk of damaging the product is reduced. Because the second portion comprises the guiding plane, there is no risk that the guiding plane would damage the product inside the box.

In a further embodiment, the guiding plane is arranged relative to the cutting edge at a cutting offset in a direction parallel to the tape plane and perpendicular to the cutting direction, wherein the cutting offset is preferably in the range of 1 mm-5 mm.

According to this embodiment, the guiding plane and the cutting are at a transverse offset from each other, i.e. transverse relative to the cutting direction. Due to this offset, when the adhesive tape is cut by the cutting edge, the cutting edge extends inside the box whereas the guiding plane is arranged outside the box and aside from the cut adhesive tape, seen in the transverse direction. This allows for improved guiding of the box cutter in the cutting direction, while preventing the cutting edge from extending into the box too deeply.

In an embodiment, the second portion comprises two of cutting edges, which are arranged opposite to each other, seen in the cutting direction, wherein a first one of the cutting edges faces in the cutting direction, and wherein a second one of the cutting edges faces in a reverse cutting direction, aligned in the tape plane and anti-parallel with the cutting direction.

The two cutting edges enable the box cutter to be used in two directions, i.e. the cutting direction and the reverse cutting direction. This may enable cutting of the adhesive tape in a pushing movement and a pulling movement of the user, which may provide for more versatile usage of the box cutter, depending on the preferences of the user. This may further improve the user-friendliness of the present box cutter, especially in contrast to knives, which can typically only be used in a single, i.e. pulling, cutting direction.

In an embodiment, the second portion is further provided with a puncturing edge, to puncture the adhesive tape when moving the box cutter relative to the adhesive tape in a puncturing direction at least having a component perpendicular to the tape plane, wherein the puncturing edge adjoins the cutting edge, and wherein the puncturing edge faces away from the second portion in the three-dimensional state of the box cutter.

According to this embodiment, the box cutter can be used effectively to puncture the adhesive tape when placing the box cutter on the adhesive tape with its second portion, which placement may be carried out in a direction having at least a component in a direction perpendicular to the tape plane. The puncturing edge may thereby contact the adhesive tape first and may extend into the adhesive tape and the box before the second portion comes in contact with the adhesive tape.

The puncturing edge adjoins the cutting edge, for example being arranged in the same plane, so that the cutting of the adhesive tape, when moving the box cutter in the cutting direction or the reverse cutting direction, can be initiated from the puncture in the adhesive tape that is made by the puncturing edge.

The present embodiment of the box cutter with puncturing edge may be especially beneficial in combination with the two cutting edges, in which the puncturing edge may be arranged in between the both cutting edges. The adhesive tape can then be punctured in a midway portion of the box and can be pushed and pulled in two directions, i.e. the cutting direction and the reverse cutting direction, instead of requiring the adhesive tape to be cut from a side of the box and an edge of the adhesive tape.

In an embodiment, the body is made from a single piece of material.

According to this embodiment, the body with the first portion and the second portion are made from a single piece of material. This allows easy manufacturing of the body, because no assembly is needed to form the body. Due to this easy manufacturing, the body may be made in a cost-effective way. For example, the single piece of material is a metal or a plastic or a ceramic. For example, the metal comprises steel or aluminum or copper. For example, the cutting edge is formed from the same piece of material. Alternatively, the cutting edge made from another material and attached to the body.

In an embodiment, the single piece of material is made from plate material with a thickness of less than 1.0 mm, preferably less than 0.5 mm, more preferably 0.4 mm. The thickness extends in a direction in the tape plane and perpendicular to the cutting direction.

According to this embodiment, the box cutter has only a very small thickness. The small thickness allows the box cutter to be made by using only a minimum amount of material. This allows for a cost-effective box cutter. Also, the small thickness allows for an easy attachment of the box cutter to the outer surface of the box. Because of the small thickness, the box cutter extends from the outside of the box only a very limited amount. In case the depression is provided, only a shallow depression is needed to arrange the box cutter completely in the depression. The small thickness is sufficient to provide enough strength and stiffness to the box cutter, because the cutting direction is perpendicular to the thickness. So by making the box cutter with a sufficient length and width, for example of several centimeters, the box cutter is able to be properly handled to cut the adhesive tape.

In an embodiment, the single piece of material is steel, preferably stainless steel.

According to this embodiment, steel is used, because this is a relatively cheap material that provides sufficient strength and stiffness. Also, part of the steel body may be sharpened to create the cutting edge. This way, the cutting edge is integrated in the body. Even though steel has a relatively high hardness that could easily scratch softer surfaces, the convex shape of the leading portion prevents or reduces scratching of the product when opening the box.

The use of stainless steel may be further beneficial in being corrosion-resistant, thus enable a more durable box cutter compared to box cutters made of corrosive materials.

In an embodiment, the first portion forms a handle for moving the box cutter manually in the cutting direction.

According to this embodiment, the first portion extends outside the box when cutting the adhesive tape. By forming a handle with the first portion, the box cutter can be easily handled. When moving in the cutting direction, the handle may be located above the cutting edge.

According to the third aspect of the invention, there may be provided a box cutter for use in one or both of the methods of the first aspect and the second aspect. The box cutter is for opening the box closed with adhesive tape extending in a tape plane. The box cutter comprises a body having a first portion and a second portion. The first portion and the second portion together form a recess for receiving an edge of the adhesive tape. The recess is adapted to receive the edge of the adhesive tape with the first portion on a first side of the tape plane, and with the second portion on a second side of the tape plane opposite to the first side. The recess is provided with a cutting edge to cut the adhesive tape when moving the box cutter relative to the adhesive tape in a cutting direction in the tape plane. The second portion has outer edge extending in a plane perpendicular to the tape plane. The outer edge has an outer portion and a leading portion. The outer portion is furthest away from the tape plane. The leading portion extends from the outer portion towards the recess. The leading portion is convex.

According to the third aspect, to cut the adhesive tape with the box cutter, the box cutter is placed with an edge of the adhesive tape in the recess. In this position, the first portion extends outside the box, whereas the second portion extends inside the box. Because the product is inside the box, the second portion has the potential to damage the product. However, because the leading portion that extends from the outer portion towards the recess is convex, if the second portion would contact the product during a movement in the cutting direction, the convex shape of the leading portion would gently push the product away from the tape plane. The convex shape prevents the second portion from sticking into the product or cutting the product. As a result, the box cutter reduces the risk of the product being damaged while opening the box.

The recess has a shape to receive an edge of the adhesive tape. For example, the recess has a slot-shape or a rectangular shape. The recess has a cutting edge that is arranged to cut the adhesive tape starting at the edge when moving the box cutter in the cutting direction. For example, in addition, the recess has a shape to receive an edge of a cardboard part of the box. In this example, the cutting edge is able to cut cardboard. This, for example, allows the box cutter to have further use as a general cutting tool. For example, this allows the box cutter to be used to cut the box into pieces in case the cardboard box is not reused by discarded.

When the edge of the adhesive tape is in the recess in a position in which the cutting edge is able to cut the edge of the adhesive tape, the first portion extends on one side of the tape, whereas the second portion extends on the opposite side of the tape. The first portion extends on one side of the tape plane, whereas the second portion extends on the opposite side of the tape plane. For example, in this position, the first portion extends outside the box, whereas the second portion extends inside the box, i.e., within a space defined by the outer surfaces of the box.

The tape plane is a plane defined by the length and the width of the adhesive tape. The adhesive tape has an adhesive on one side of the tape plane and no adhesive on the other side of the tape plane. When cutting the adhesive tape, the cut is made in the tape plane in the length direction, the width direction or a combination of the length direction and the width direction.

The outer portion is the portion of the second portion that extends the most towards the product when cutting the adhesive tape. The outer portion is, for example, only a small portion, such as a small circle segment. The outer portion is, for example, relatively large, such as a linear segment extending over 1 cm or more.

The leading portion is convex which causes, in case there is contact between the product and the leading portion, the product to be moved away from the tape plane. The convex shape of the leading portion bulges in the cutting direction. The convex shape of the leading portion is in the cutting direction relative to a center of the curvature of the convex shape.

In an embodiment, the leading portion has a radius of at least 1 mm, preferably at least 2 mm, more preferably at least 4 mm.

According to this embodiment, the leading portion is convex with a radius of at least 1 mm. For many products, the radius of 1 mm is sufficient to prevent damage in case the leading portion would hit the product inside the box. For delicate products, such as textiles or products with a high quality finish, a larger radius may be preferred. For example, the radius is at least 2 mm. With such a radius, the force of the leading portion on the product is further reduces. For some products, like knitwear or products with wires that stick out, a radius of at least 4 mm is preferred. With such a large radius, it may be prevented that the leading portion hooks in a loop of the knitwear. If this were to happen, the loop would be pulled from the knitwear, damaging the knit wear.

In an embodiment, the first portion comprises a guiding edge facing the tape plane and extending parallel to the tape plane. The guiding edge is adapted to guide the box cutter along the box in the cutting direction. The guiding edge is adapted to move along the tape in the cutting direction.

According to this embodiment, the guiding edge helps to guide the box cutter along the box in the cutting direction. Because the guiding edge faces the tape plane and extends parallel to the tape plane, the guiding edge helps to guide the box cutter along the box while reducing the risk of placing the box cutter too deeply into the box. The adhesive tape forms a support for the guiding edge as a result. This way, the risk of damaging the product is reduced. Because the first portion comprises the guiding edge, there is no risk that the guiding edge would damage the product inside the box.

In an embodiment, the guiding edge is arranged relative to the recess in the cutting direction.

According to this embodiment, when moving the box cutter in the cutting direction, the guiding edge is in front of the recess. As a result, the guiding edge is supported by an uncut part of the tape, allowing for a good support. This way, the risk of cutting too deep into the box is reduced.

In an embodiment, the guiding edge extends parallel to the tape plane for at least 1 cm, preferably at least 2 cm, more preferably at least 3 cm.

According to this embodiment, the guiding edge extends parallel to the tape plane for a substantial length. Because of this substantial length, the guiding edge is able to guide the box cutter more accurately along the cutting direction

In an embodiment, the guiding edge is arranged relative to the outer portion at an offset in a direction perpendicular to the tape plane, wherein the offset is preferably in the range of 3-4 mm.

According to this embodiment, the guiding edge and the outer portion are at an offset from each other. Due to this offset, when the adhesive tape is in the recess, the outer portion extends inside the box whereas the guiding edge is outside the box. This allows for improved guiding of the box cutter in the cutting direction, while preventing the second portion from extending into the box too deeply.

In an embodiment, the outer portion is parallel to the tape plane.

Because the outer portion is parallel to the tape plane, the outer portion may have a substantial length without increasing the width of the second portion. The length is in the cutting direction. The width of the second portion is perpendicular to the tape plane. Because of the substantial length of the outer portion, the second portion may form a recess with a large length. Having a recess with a large length is beneficial to properly position the edge of the adhesive tape in the recess and helps with properly cutting the adhesive tape.

In an embodiment, the outer portion is convex.

Because the outer portion is convex, the outer portion and the leading portion form a large convex edge that is able to gently push the product to the side while moving in the cutting direction. This embodiment is especially beneficial with the product is flexible, such as clothing.

In a fourth aspect of the invention, there is provided a box opening assembly for use in the method mentioned in the embodiments above. The box opening assembly comprises the box cutter according to any one of the embodiments mentioned above; and the sheet having a first adhesive portion and a second adhesive portion. The box cutter is attached to the sheet via the first adhesive portion. The second adhesive portion is for attaching the sheet to the outer surface of the box.

According to this embodiment, the box opening assembly has a box cutter according to any one of the embodiments mentioned above. The box cutter is adhered to the sheet via the first adhesive portion. The first adhesive portion has an adhesive that holds the box cutter and the sheet together. However, the customer is able to remove the box cutter from the first adhesive portion in order to use the box cutter to cut the adhesive tape.

The box opening assembly is simply attached to the outer surface of a box by placing the second adhesive portion into contact with the outer surface. The second adhesive portion holds the sheet onto the box, whereas the sheet holds the box cutter onto the box.

For example, the box opening assembly is provided with a release paper that covers the box cutter and the second adhesive portion prior to attaching the box opening assembly to the box. The release paper is a paper of plastic-base sheet that prevents the second adhesive portion form prematurely adhering. When it is time to adhere the box opening assembly to the box, the release paper is removed exposing the second adhesive portion. Then, the second adhesive portion is pressed onto the box to attach the box opening assembly to the box.

In a fifth aspect of the invention, there is provided a box provided with the box opening assembly of the fourth aspect of the invention. The box has an outer surface. The box opening assembly is attached to the outer surface.

### BRIEF DESCRIPTION OF DRAWINGS

The invention will be described in more detail below under reference to the figures. In the figures exemplary embodiments of the invention are shown. The figures show in:

FIG. 1: a first embodiment of the invention,

FIG. 2: a detail of the first embodiment,

FIG. 3: part of a method for opening a box according to the first embodiment,

FIG. 4: a box cutter according to the first embodiment,

FIG. 5: a detail of the box cutter of FIG. 4,

FIG. 6: a box cutter according to a second embodiment of the invention,

FIG. 7: a third embodiment of the invention,

FIG. 8: opening the box according to an embodiment of the invention,

FIG. 9: a box cutter according to a third embodiment in a plan view in its two-dimensional state,

FIG. 10: the box cutter of FIG. 9 in a perspective view,

FIG. 11: the box cutter of FIG. 10 in its three-dimensional state,

FIG. 12: part of a method for opening a box according to a fifth embodiment of the invention, and

FIG. 13: opening the box according to an embodiment of the invention.

### DETAILED DESCRIPTION OF EMBODIMENTS

To explain the invention, the figures make use of a cartesian coordinate system. The x-axis and y-axis define a horizontal plane. The z-axis defines a vertical axis. The x-, y- and z-axes are perpendicular to each other. It is noted that the invention may have any other orientation.

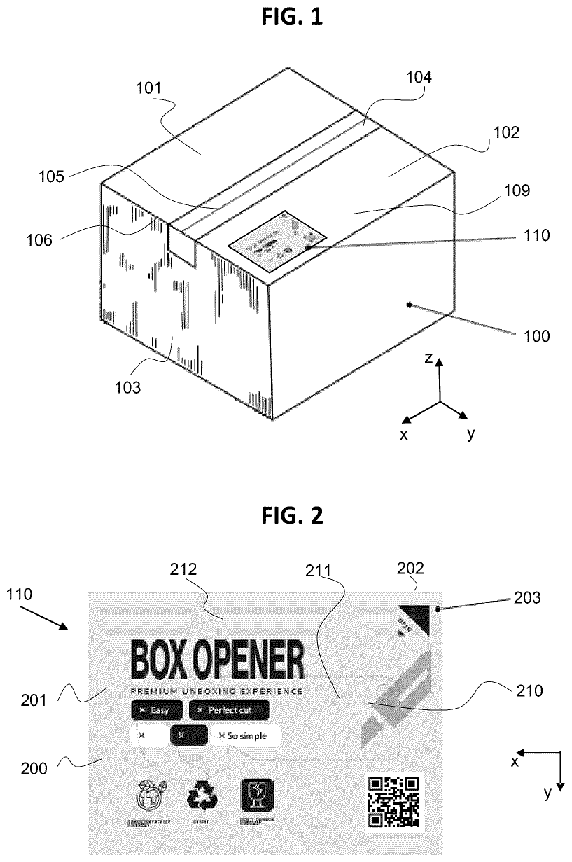

FIG. 1 depicts a first embodiment of the invention. FIG. 1 depicts a box 100 that has an outer surface 109 on which a box opening assembly 110 is attached. The box 100 is made of cardboard. The box 100 has a first major flap 101, a second major flap 102, and a side panel 103. The outer surface 109 is the outer surface of the second major flap 102. An adhesive tape 104 is provided on the first major flap 101, the second major flap 102 and the side panel 103 to close the box 100. The part of the adhesive tape 104 that adheres on the first major flap 101 and the second major flap 102, extends in a tape plane 404 parallel to the xy-plane. The part of the adhesive tape 104 that adheres on the side panel 103 extends in a tape plane 404 parallel to the yz-plane. There is a first space 105 between the first major flap 101 and the second major flap 102 which is covered by the adhesive tape 104. There is a second space 106 respectively between the first major flap 101 and the side panel 103, and between the second major flap 102 and the side panel 103. The second space 106 is covered by the adhesive tape 104.

FIG. 2 depicts the box opening assembly 110. The box opening assembly 110 has a box cutter 210 and a sheet 200. The sheet 200 covers the box cutter 210. The location of the box cutter 210 is indicated with the dashed lines in the figure.

The sheet 200 has a first surface 201, i.e., the top surface that is visible in the figure. The sheet 200 has a second surface 202 opposite to the first surface 201. The second surface 202 has a first adhesive portion 211 and a second adhesive portion 212. The box cutter 210 is attached to the sheet 200 via the first adhesive portion 211. The second adhesive portion 212 is for attaching the sheet 200 to the outer surface 109 of the box 100. The sheet 200 is a sticker. Optionally, the sheet 200 is an address label having address information.

To attach the box cutter 210 to the box 100, a method is performed comprising the steps of arranging the box cutter 210 on the outer surface 109 of the box 100; and attaching the box cutter 210 to the outer surface 109.

The step of attaching the box cutter 210 to the outer surface 109 optionally comprises the steps of arranging the sheet 200 at least partly over the box cutter 210; and attaching the sheet 200 to the box 100.

The sheet 200 has a pull tab 203 for removing the sheet 200 from the box 100.

Optionally, the sheet 200 has a transparent portion. The step of arranging the sheet 200 over the box cutter 210 optionally comprises the step of arranging the transparent portion over at least part of the box cutter 210 to allow the box cutter 210 to be visible through the sheet 200.

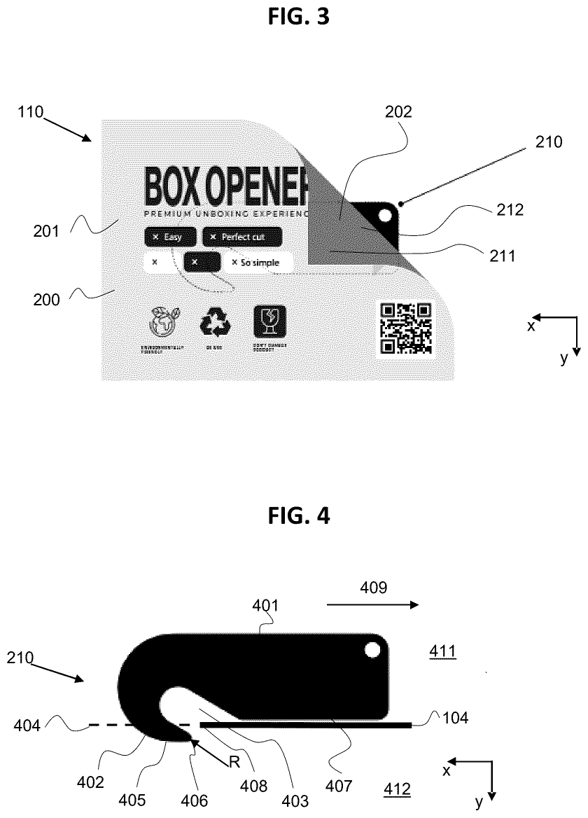

FIG. 3 depicts part of a method for opening a box 100 according to the first embodiment. The method comprises the step of at least partially removing the sheet 200 from the box cutter 210 by pulling the pull tab 203 to gain access to the box cutter 210. By pulling the pull tab 203, the second surface 202 is partly exposed, showing the first adhesive portion 211 and the second adhesive portion 212. By removing the sheet 200 from the box cutter 210, the box cutter 210 may be removed from the outer surface 109 of the box 100. Then the adhesive tape 104 can be cut with the box cutter 210.

FIG. 4 depicts a box cutter 210 according to the first embodiment of the invention. The box cutter 210 is for example used in the methods described above.

The box cutter 210 is for opening the box 100 closed with adhesive tape 104 extending in a tape plane 404. The box cutter 210 comprises a body having a first portion 401 and a second portion 402.

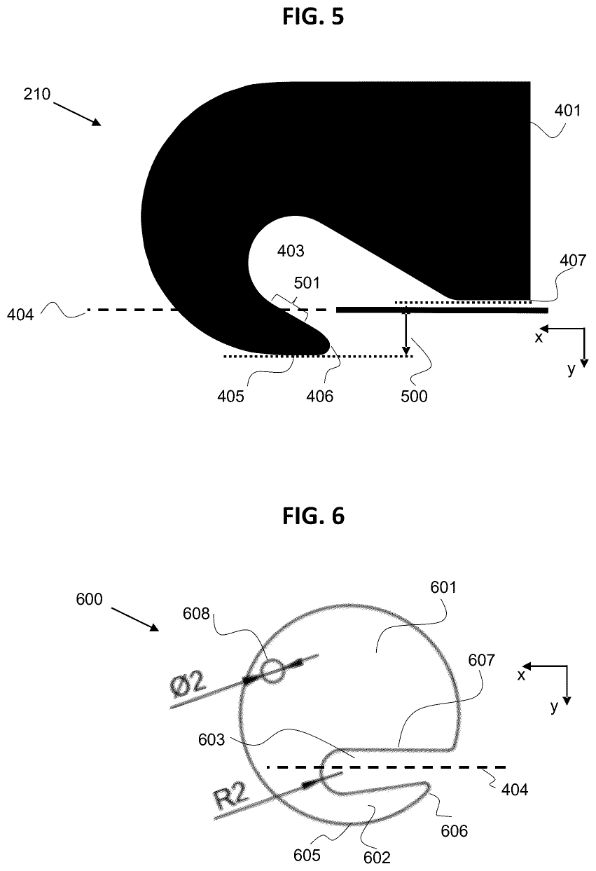

The first portion 401 and the second portion 402 together form a recess 403 for receiving an edge 408 of the adhesive tape 104. The recess 403 is adapted to receive the edge 408 of the adhesive tape 104 with the first portion 401 on a first side 411 of the tape plane 404, and with the second portion 402 on a second side 412 of the tape plane 404 opposite to the first side. The recess 403 is provided with a cutting edge 501, see FIG. 5, to cut the adhesive tape 104 when moving the box cutter 210 relative to the adhesive tape 104 in a cutting direction 409 in the tape plane 404. The second portion 402 has an outer edge extending in a plane perpendicular to the tape plane 404. The outer edge has an outer portion 405 and a leading portion 406. The outer portion 405 is furthest away from the tape plane 404. The leading portion 406 extends from the outer portion 405 towards the recess 403. The leading portion 406 is convex and has a radius R.

The cutting direction 409 is indicated with an arrow. The arrow represents the movement of box cutter 210 relative to the adhesive tape 104 while cutting the adhesive tape 104.

The body is made from a single piece of material. The single piece of material is made from plate material with a thickness of less than 1.0 mm, preferably less than 0.5 mm, more preferably 0.4 mm. The thickness extends in a direction in the tape plane 404 and perpendicular to the cutting direction 409, i.e., the z-direction. The single piece of material is steel.

The radius R of the leading portion 406 has a radius of at least 1 mm, preferably at least 2 mm, more preferably at least 4 mm.

The first portion 401 comprises a guiding edge 407 facing the tape plane 404 and extending parallel to the tape plane 404, i.e., extending in parallel to the x-axis. The guiding edge 407 is adapted to guide the box cutter 210 along the box 100 in the cutting direction 409. The guiding edge 407 is adapted to move, for example slide, along the adhesive tape 104 in the cutting direction 409. The guiding edge 407 is arranged relative to the recess 403 in the cutting direction 409. This means that the guiding edge 407 is in front of the recess 403 when moving in the cutting direction 409.

The guiding edge 407 extends parallel to the tape plane 404 for at least 1 cm, preferably at least 2 cm, more preferably at least 3 cm. The first portion 401 forms a handle for moving the box cutter 210 manually in the cutting direction. The handle is arranged relative to the recess 403 in the cutting direction 409.

FIG. 5 depicts a detail of the box cutter 210 of FIG. 4. FIG. 5 shows that the guiding edge 407 is arranged relative to the outer portion 405 at an offset 500 in a direction perpendicular to the tape plane 404. The offset 500 is preferably in the range of 3-4 mm. The outer portion 405 is parallel to the tape plane 404. The cutting edge 501 is arranged in the recess 403.

FIG. 6 depicts a box cutter 210 according to a second embodiment of the invention. The box 100 cutter has, for example, the same elements as the box cutter 210 according to the first embodiment, except for the following. The box cutter 210 according to the second embodiment has a body having a first portion 601 and a second portion 602. The first portion 601 and the second portion 602 together form a recess 603 for receiving an edge 408 of the adhesive tape 104. The recess 603 is adapted to receive the edge 408 of the adhesive tape 104 with the first portion 601 on a first side 411 of the tape plane 404, and with the second portion 602 on a second side 412 of the tape plane 404 opposite to the first side 411. The recess 603 is provided with a cutting edge 501 to cut the adhesive tape 104 when moving the box cutter 210 relative to the adhesive tape 104 in the cutting direction 409 in the tape plane 404. The second portion 602 has outer edge extending in a plane perpendicular to the tape plane 404. The outer edge has an outer portion 605 and a leading portion 606. The outer portion 605 is furthest away from the tape plane 404. The leading portion 606 extends from the outer portion 605 towards the recess 603. The leading portion 606 is convex. The outer portion 605 is convex.

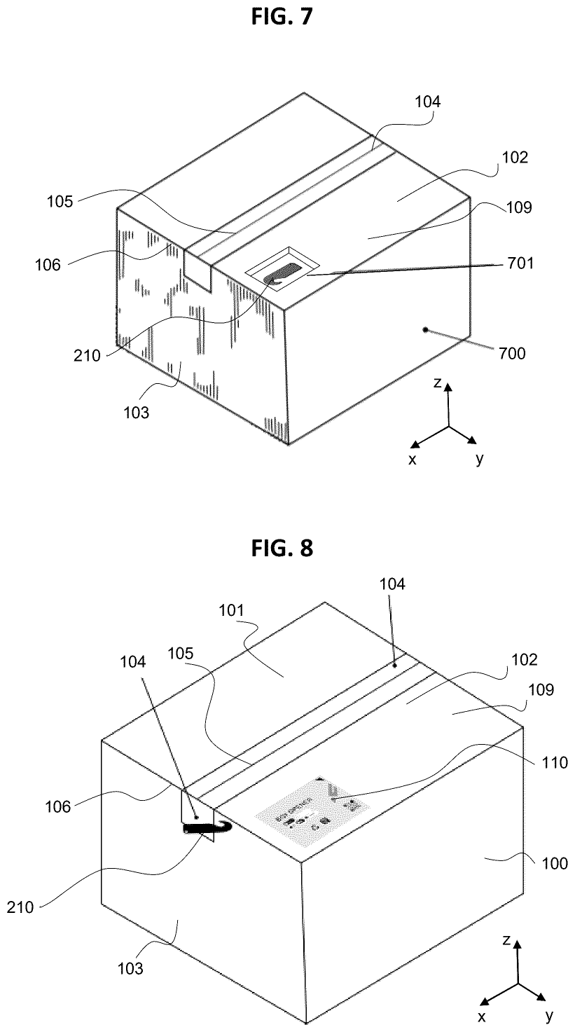

FIG. 7 depicts a third embodiment of the invention. The third embodiment is, for example, the same as any of the embodiment described above, except for the following. A box 700 is provided with a depression 701. The depression 701 is provided in the outer surface 109 of the box 100. The box cutter 210 is arranged in the depression 701. The box cutter 210 is attached to the box 100 in the depression 701 by gluing the box cutter 210 to the outer surface 109 in the depression 701.

FIG. 8 depicts part of opening the box 100 according to an embodiment of the invention. This embodiment has, for example, the same elements as any of the embodiments described above. The box 100 is closed with adhesive tape 104. The box cutter 210 is attached to the box 100 according to embodiment described above. The box cutter 210 has been removed from the outer surface 109 of the box 100. The box cutter 210 is used to cut the adhesive tape 104. The box cutter 210 has a thickness that is small enough to fit in the space 106 between the first major flap 101 and the side panel 103, and between the second major flap 102 and the side panel 103 to cut the adhesive tape 104. Also, the box cutter 210 has a thickness that is small enough to fit in the space 105 between the first major flap 101 and the second major flap 102 to cut the adhesive tape 104.

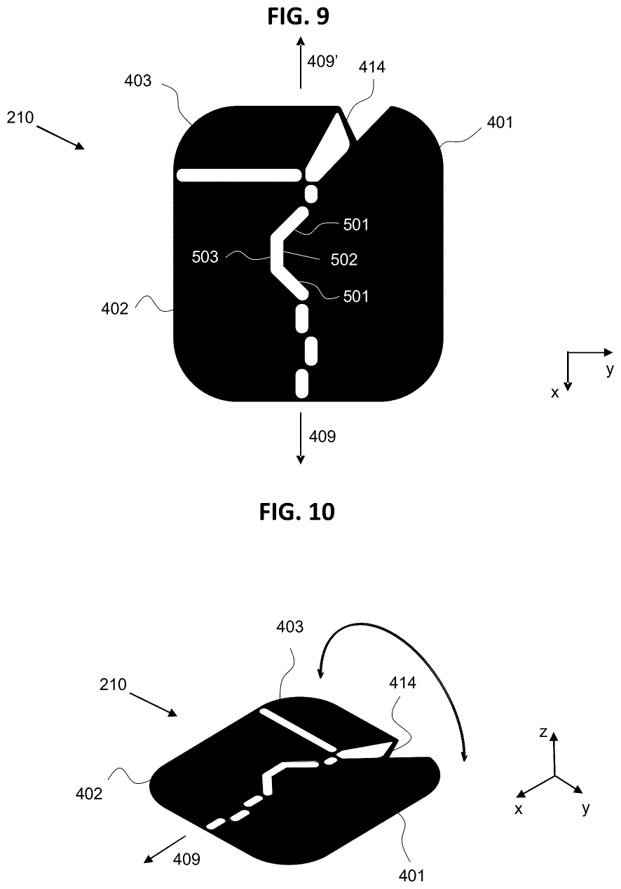

FIG. 9 depicts a box cutter 210 according to a third embodiment. The box cutter 210 is depicted in a plan view and is arranged in its two-dimensional state. The box cutter 210 comprises a body having a first portion 401, a second portion 402 and a third portion 403. The portions 401, 402, 403 extend co-planar with each other in the two-dimensional state of the box cutter 210 that is shown in FIG. 9. The body is made from a single piece of material and the portions 401, 402, 403 are integrally and bendably connected to each other. The box cutter 210 is configured to be arranged in the substantially two-dimensional state of FIG. 9 during shipping of the box 100 to which the box cutter 210 is attached. In this two-dimensional state.

The box cutter 210 comprises two cutting edges 501 that are provided on the first portion 501. The cutting edges 501 are arranged opposite to each other, seen in the cutting direction 409 A first one of the cutting edges 501 faces in the cutting direction 409 and a second one of the cutting edges 501 faces in a reverse cutting direction 409′, aligned anti-parallel with the cutting direction 409, to enable cutting of the adhesive tape 104 in a pushing movement and a pulling movement of the user.

The second portion 402 is further provided with a puncturing edge 501, to puncture the adhesive tape 104 when moving the box cutter 210 relative to the adhesive tape 104 in a puncturing direction at least having a component perpendicular to the tape plane 404. The puncturing edge 502 adjoins the cutting edges 501 and is arranged in the same plane being arranged in between the both cutting edges 501.

In the two-dimensional state of the box cutter 210 shown in FIG. 9, the cutting edges 501 are accommodated in a cavity 503 of the second portion 402, in order to be substantially shielded, i.e. to avoid damaging of any sheet 110 or other type of covering over the box cutter 210 during shipping of the box 100.

The third portion 403 is functionally arranged between the first portion 401 and the second portion 402 and is connected to the second portion 402 through a connecting element 414.

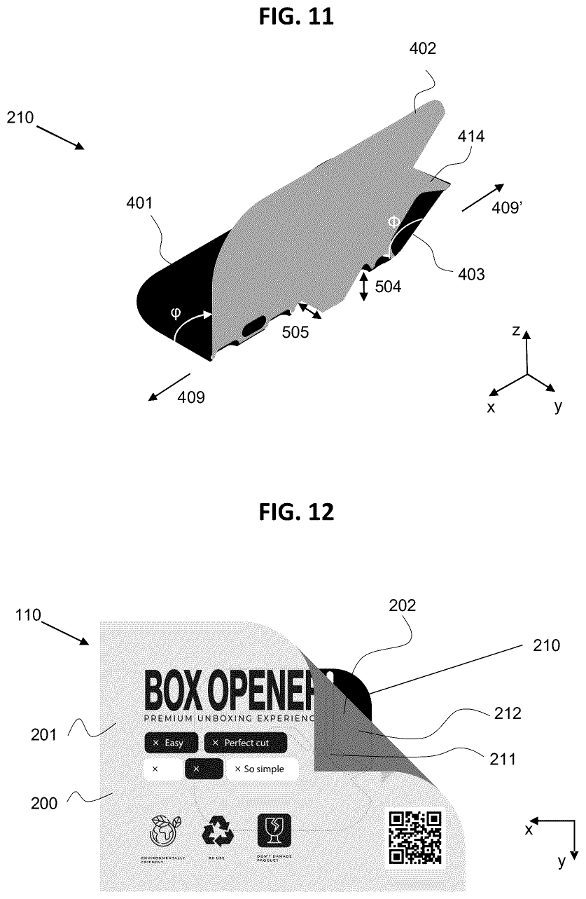

FIG. 10 shows the box cutter of FIG. 9 in a perspective view, in which it is visible that the first portion 401 and the second portion 402 are bendable relative to each other, as indicated by the arc-shaped arrow. The box cutter 210 is bendable between the two-dimensional state shown in FIG. 9 and a substantially three-dimensional state, which is shown in FIG. 11, in which the first portion 401 and the second portion 402 extend at a bending angle o relative to each other. After the shipping, when the user intends to open the box 100 and to cut the adhesive tape 104, the box cutter 210 is intended to be bent into its three-dimensional shape. Upon bending of the first portion 401 and the second portion 402 of the box cutter 210, the cutting edges 501 and the puncturing device 502 are moved out of the cavity 503, in order to be exposed and to be able of cutting the adhesive tape 104.

The third portion 403 is configured to guide the bending between the first portion 401 and the second portion 402, to ensure that the box cutter 210 is correctly bent into the three-dimensional state. The third portion 403 is thereby configured to allow bending of the first portion 401 relative to the second portion 402 as long as the angle between them, i.e. starting a 0° in the two-dimensional state shown in FIG. 10, has not yet reached the bending angle φ. However, when the angle between the first portion 401 and the second portion 402 does reach the bending angle φ, the third portion 403 is configured to stop further bending, so over-bending beyond the bending angle φ is prevented.

The length of the connecting element 414 thereby determines the bending angle φ. If, for example, the length of the connecting element 414 is relatively short, the bending angle φ is relatively small, whereas the bending angle φ is relative larger when the length of the connecting element 414 is relatively long. In the present embodiment, the bending angle φ is defined in the range between 45° and 135°, preferably between 60° and 120°, for example about 90°.

FIG. 11 shows the box cutter 210 of FIG. 10 in its three-dimensional state, in which the first portion 401 and the second portion 402 are bent up to a bending angle φ of 90°, thus extending at a right angle with each other. The cutting edges 501 and the puncturing edge 502 thereby project away from, e.g. underneath, the second portion 402 at a cutting depth 504 in a direction perpendicular to the tape plane 404. The cutting depth 504, i.e. in the z-direction, is defined in the range between 1 mm and 5 mm, preferably between 2 mm and 4 mm, for example about 3 mm.

During cutting in its three-dimensional shape, the box cutter 210 is intended to be placed on the adhesive tape 104 with the second portion 402. The second portion 402 thereby forms a guiding plane facing the tape plane 404, which guiding plane of the second portion 402 is adapted to support and guide the box cutter 210 along the box 100 in the cutting direction 409. During cutting, the cutting edges 501 project into the adhesive tape 104, whereas the second portion 402 resting on the adhesive tape 104 prevents the cutting edges 501 from sinking too deep into the box 100.

The guiding plane of the second portion 402 is arranged relative to the cutting edges 501 at a cutting offset 505 in a direction parallel to the tape plane 404 and perpendicular to the cutting direction 409, i.e. in the y-direction. The cutting offset 505 is in the range of 1 mm-5 mm.

In the three-dimensional state of the box cutter 210, the first portion 401 forms a handle for moving the box cutter 210 manually in the cutting direction 409. The first portion 401 thereby extends outside the box 100 when cutting the adhesive tape 104. When moving in the cutting direction 409, the handle is located above the cutting edges 501 and the puncturing edge 502.

It is further shown in FIG. 11 that the third portion 403 is bent out of the plane of the second portion 402 when the box cutter 210 is brought into the three-dimensional state. In the three-dimensional state, the third portion 403 can beneficially act as a skid plate to facilitate sliding of the second portion 402 of the box cutter 201 over minor obstructions on the adhesive tape 104, i.e. when moving in the reverse cutting direction 409′.

The third portion 403 extends at a tail angle ϕ relative to the second portion 402. The tail angle ϕ of the third portion 403 is different from the bending angle φ, but both angles are dependent from each other through the length of the connecting element 414 between the third portion 403 and the second portion 402.

FIG. 12 depicts another embodiment of a box opening assembly 110, which comprises the box cutter 210 according to the second embodiment and a sheet 200 similar as the sheet 100 shown in FIG. 3. The sheet 200 covers the box cutter 210. The location of the box cutter 210 is indicated with the dashed lines in the figure. FIG. 9 depicts part of a method for opening a box 100 according to the fourth embodiment. The method comprises the step of at least partially removing the sheet 200 from the box cutter 210 by pulling the pull tab 203 to gain access to the box cutter 210. By pulling the pull tab 203, the second surface 202 is partly exposed, showing the first adhesive portion 211 and the second adhesive portion 212. By removing the sheet 200 from the box cutter 210, the box cutter 210 may be removed from the outer surface 109 of the box 100. Then the adhesive tape 104 can be cut with the box cutter 210.

According to this fourth embodiment, the box cutter 210 is attached to the box 100 in a substantially two-dimensional state, so that the box cutter 210 is relatively flat during shipping of the box 100. The method further comprises, after the step of removing the box cutter 210 from the box 100, the step of bending the box cutter 210 into a substantially three-dimensional state.

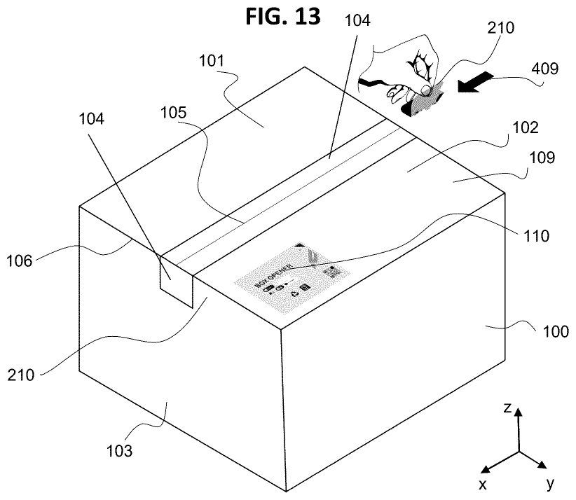

FIG. 13 depicts part of opening the box 100 according to an embodiment of the invention. This embodiment has, for example, the same elements as any of the embodiments described above. The box 100 is closed with adhesive tape 104. The box cutter 210 is attached to the box 100 according to embodiment described above. The box cutter 210 has been removed from the outer surface 109 of the box 100 and has been brought into its substantially three-dimensional state, being gripped by a user at the first portion of the box cutter 210. The box cutter 210 is used to cut the adhesive tape 104. The box cutter 210 has a thickness that is small enough to fit in the space 106 between the first major flap 101 and the side panel 103, and between the second major flap 102 and the side panel 103 to cut the adhesive tape 104. Also, the box cutter 210 has a thickness that is small enough to fit in the space 105 between the first major flap 101 and the second major flap 102 to cut the adhesive tape 104.

This document describes detailed embodiments of the invention. However it must be understood that the disclosed embodiments serve exclusively as examples, and that the invention may be implemented in other forms.

### EMBODIMENTS

1. Method for attaching a box cutter (210) to a box (100), the method comprising the steps of:
   arranging the box cutter (210) on an outer surface (109) of the box (100);
   attaching the box cutter (210) to the outer surface (109).
2. Method according to embodiment 1, wherein the step of attaching the box cutter (210) to the outer surface (109) comprises the step of gluing the box cutter (210) to the outer surface (109).
3. Method according to embodiment 1 or 2, comprising the step of providing a depression (701) in the outer surface (109) of the box (100),
   wherein the step of arranging the box cutter (210) on the outer surface (109) of the box (100) comprises arranging the box cutter (210) in the depression (701).
4. Method according to any one of the preceding embodiments, wherein the step of attaching the box cutter (210) to the outer surface (109) comprises the steps of:
   arranging a sheet (200) at least partly over the box cutter (210);
   attaching the sheet (200) to the box (100).
5. Method according to embodiment 4, wherein the sheet (200) is an address label.
6. Method according to embodiment 4 or 5, wherein the sheet (200) is a sticker.
7. Method according to any one of embodiments 4-6, wherein the sheet (200) has a transparent portion, wherein the step of arranging the sheet (200) over the box cutter (210) comprises the step of:
   arranging the transparent portion over at least part of the box cutter (210) to allow the box cutter (210) to be visible through the sheet (200).
8. Method for opening a box (100) closed with adhesive tape (104), wherein a box cutter (210) is attached to the box (100) according to method of any one of embodiments 4-7, the method comprising the steps of:
   at least partially removing the sheet (200) from the box cutter (210) to gain access to the box cutter (210);
   removing the box cutter (210) from the outer surface (109) of the box (100);
cutting the adhesive tape (104) with the box cutter (210).
9. Method according to embodiment 8, wherein the sheet (200) has a pull tab (203) for removing the sheet (200) from the box (100), wherein the step of at least partly removing the sheet (200) from the box cutter (210) comprises pulling the pull tab (203).
10. Box cutter (210) for use in the method of embodiments 1-7 and/or for the method of embodiments 8-9, wherein the box cutter (210) is for opening the box (100) closed with adhesive tape (104) extending in a tape plane (404), the box cutter (210) comprising a body having a first portion (401) and a second portion (402),
   wherein the first portion (401) and the second portion (402) together form a recess (403) for receiving an edge (408) of the adhesive tape (104),
   wherein the recess (403) is adapted to receive the edge (408) of the adhesive tape (104) with the first portion (401) on a first side (411) of the tape plane (404), and with the second portion (402) on a second side (412) of the tape plane (404) opposite to the first side (411),
   wherein the recess (403) is provided with a cutting edge (501) to cut the adhesive tape (104) when moving the box cutter (210) relative to the adhesive tape (104) in a cutting direction (409) in the tape plane (404),
   wherein the second portion (402) has outer edge extending in a plane perpendicular to the tape plane (404),
   wherein the outer edge has an outer portion (405) and a leading portion (406),
   wherein the outer portion (405) is furthest away from the tape plane (404),
   wherein the leading portion (406) extends from the outer portion (405) towards the recess (403),
   wherein the leading portion (406) is convex.
11. Box cutter (210) according to any one of the preceding embodiments, wherein the body is made from a single piece of material.
12. Box cutter (210) according to embodiment 11, wherein the single piece of material is made from plate material with a thickness of less than 1.0 mm, preferably less than 0.5 mm, more preferably 0.4 mm, wherein the thickness extends in a direction in the tape plane (404) and perpendicular to the cutting direction (409).
13. Box cutter (210) according to any one of embodiments 10-12, wherein the single piece of material is steel.
14. Box cutter (210) according to any one of any one of embodiments 10-13, wherein the leading portion (406) has a radius of at least 1 mm, preferably at least 2 mm, more preferably at least 4 mm.
15. Box cutter (210) according to any one of the embodiments 10-14, wherein the first portion (401) comprises a guiding edge (407) facing the tape plane (404) and extending parallel to the tape plane (404),
   wherein the guiding edge (407) is adapted to guide the box cutter (210) along the box (100) in the cutting direction,
   wherein the guiding edge (407) is adapted to move along the adhesive tape (104) in the cutting direction (409).
16. Box cutter (210) according to embodiment 15, wherein the guiding edge (407) is arranged relative to the recess (403) in the cutting direction (409).
17. Box cutter (210) according to embodiment 15 or 16, wherein the guiding edge (407) extends parallel to the tape plane (404) for at least 1 cm, preferably at least 2 cm, more preferably at least 3 cm.
18. Box cutter (210) according to any one of embodiments 15-17, wherein the guiding edge (407) is arranged relative to the outer portion (405) at an offset (500) in a direction perpendicular to the tape plane (404), wherein the offset (500) is preferably in the range of 3-4 mm.
19. Box cutter (210) according to any one of embodiments 15-18, wherein the outer portion (405) is parallel to the tape plane (404).
20. Box cutter (210) according to any one of embodiments 15-18, wherein the outer portion (405) is convex.
21. Box cutter (210) according to any one of embodiments 10-20, wherein the first portion (401) forms a handle for moving the box cutter (210) manually in the cutting direction (409),
   wherein the handle is arranged relative to the recess (403) in the cutting direction (409).
22. Box opening assembly (110) for use in the method according to any one of embodiments 4-7, the box opening assembly (110) comprising:
   the box cutter (210) according to any one of claims 10-21,
   the sheet (200) having a first adhesive portion (211) and a second adhesive portion (212),
wherein the box cutter (210) is attached to the sheet (200) via the first adhesive portion (211),
wherein the second adhesive portion (212) is for attaching the sheet (200) to the outer surface (109) of the box (100).
23. Box (100) provided with the box opening assembly (110) of embodiment 22,
   wherein the box (100) has an outer surface (109),
   wherein the box opening assembly (110) is attached to the outer surface (109).

What is claimed is:

1. A method for attaching a box cutter to a box, the method comprising the steps of:
arranging the box cutter on an outer surface of the box;
attaching the box cutter to the outer surface.

2. The method according to claim 1, wherein the step of attaching the box cutter to the outer surface comprises the step of gluing the box cutter to the outer surface.

3. The method according to claim 1, comprising the step of providing a depression in the outer surface of the box,
wherein the step of arranging the box cutter on the outer surface of the box comprises arranging the box cutter in the depression.

4. The method according to claim 1, wherein the step of attaching the box cutter to the outer surface comprises the steps of:
arranging a sheet at least partly over the box cutter;
attaching the sheet to the box.

5. The method according to claim 4, wherein the sheet is an address label, or
wherein the sheet is a sticker, or
wherein the sheet has a transparent portion, wherein the step of arranging the sheet over the box cutter comprises the step of:
arranging the transparent portion over at least part of the box cutter to allow the box cutter to be visible through the sheet.

6. (canceled)

7. (canceled)

8. A method for opening a box closed with adhesive tape, wherein a box cutter is attached to the box according to method of claim 4, the method comprising the steps of:
at least partially removing the sheet from the box cutter to gain access to the box cutter;
removing the box cutter from the outer surface of the box;
cutting the adhesive tape with the box cutter.

9. The method according to claim 8, wherein the sheet has a pull tab for removing the sheet from the box, wherein the step of at least partly removing the sheet from the box cutter comprises pulling the pull tab.

10. The method according to claim 8, wherein the box cutter is attached to the box in a substantially two-dimensional state, and wherein the method further comprises, after the step of removing the box cutter, the step of:
bending the box cutter into a substantially three-dimensional state.

11. A box cutter for use in the method of claim 1, wherein the box cutter is for opening the box closed with adhesive tape extending in a tape plane, the box cutter comprising a body having a first portion and a second portion,
wherein the first portion and the second portion are bendable relative to each other between:
a substantially two-dimensional state, in which the first portion and the second portion extend co-planar with each other, and
a substantially three-dimensional state, in which the first portion and the second portion extend at a bending angle (φ) relative to each other,
wherein the first portion is provided with a cutting edge to cut the adhesive tape when moving the box cutter relative to the adhesive tape in a cutting direction in the tape plane,
wherein the cutting edge projects in a cavity of the second portion in the two-dimensional state of the box cutter, and
wherein the cutting edge projects away from the second portion in the three-dimensional state of the box cutter at a cutting depth in a direction perpendicular to the tape plane.

12. The box cutter according to claim 11, wherein the bending angle (φ) is defined in the range between 45° and 135°, preferably between 60° and 120°, for example about 90°.

13. The box cutter according to claim 11, wherein the cutting depth is defined in the range between 1 mm and 5 mm, preferably between 2 mm and 4 mm, for example about 3 mm.

14. The box cutter according to claim 11, further comprising a third portion, which is functionally arranged between the first portion and the second portion, configured to guide the bending between the first portion and the second portion.

15. The box cutter according to claim 14, wherein the third portion is further configured to prevent bending between the first portion and the second portion beyond the bending angle (φ).

16. The box cutter according to claim 14, further comprising a connecting element between the third portion and the second portion.

17. The box cutter according to claim 14, wherein the third portion extends co-planar with the first portion and the second portion in the two-dimensional state of the box cutter, and
wherein the third portion extends at a tail angle (Φ) relative to the second portion and the cutting direction in the three-dimensional state of the box cutter.

18. The box cutter according to claim 11, wherein, in the three-dimensional state of the box cutter, the second portion forms a guiding plane facing the tape plane and extending parallel to the tape plane,
wherein the guiding plane is adapted to support and guide the box cutter along the box in the cutting direction, and
wherein the guiding plane is adapted to move along the adhesive tape in the cutting direction.

19. The box cutter according to claim 18, wherein the guiding plane is arranged relative to the cutting edge at a cutting offset in a direction parallel to the tape plane and perpendicular to the cutting direction, wherein the cutting offset is preferably in the range of 1 mm-5 mm.

20. The box cutter according to claim 11, wherein the second portion comprises two of cutting edges, which are arranged opposite to each other, seen in the cutting direction, and
wherein a first one of the cutting edges faces in the cutting direction, and
wherein a second one of the cutting edges faces in a reverse cutting direction, aligned in the tape plane and anti-parallel with the cutting direction, or
wherein the second portion is further provided with a puncturing edge, to puncture the adhesive tape when moving the box cutter relative to the adhesive tape in a puncturing direction perpendicular to the tape plane,
wherein the puncturing edge adjoins the cutting edge, and
wherein the puncturing edge faces away from the second portion in the three-dimensional state of the box cutter, or
wherein the body is made from a single piece of material, or
wherein the single piece of material is made from plate material with a thickness of less than 1.0 mm, preferably less than 0.5 mm, more preferably 0.4 mm, wherein the thickness extends in a direction in the tape plane and perpendicular to the cutting direction, or
wherein the single piece of material is steel, for example stainless steel, or
wherein the first portion forms a handle for moving the box cutter manually in the cutting direction.

21-25. (canceled)

26. A box opening assembly for use in the method according to claim 4, the box opening assembly comprising:
a box cutter, comprising a body having a first portion and a second portion,
wherein the first portion and the second portion are bendable relative to each other between:
a substantially two-dimensional state, in which the first portion and the second portion extend co-planar with each other, and
a substantially three-dimensional state, in which the first portion and the second portion extend at a bending angle (φ) relative to each other,
wherein the first portion is provided with a cutting edge to cut the adhesive tape when moving the box cutter relative to the adhesive tape in a cutting direction in the tape plane,
wherein the cutting edge projects in a cavity of the second portion in the two-dimensional state of the box cutter, and
wherein the cutting edge projects away from the second portion in the three-dimensional state of the box cutter at a cutting depth in a direction perpendicular to the tape plane,
the sheet having a first adhesive portion and a second adhesive portion,
wherein the box cutter is attached to the sheet via the first adhesive portion,
wherein the second adhesive portion is for attaching the sheet to the outer surface of the box.

27. A box provided with the box opening assembly of claim 26, wherein the box has an outer surface,
wherein the box opening assembly attached to the outer surface.
